(19) United States
(12) Patent Application Publication
(10) Pub. No.: US 2014/0143302 A1
(43) Pub. Date: May 22, 2014

(54) FILE-OPENING SYSTEM AND METHOD

(71) Applicant: INSTITUTE FOR INFORMATION INDUSTRY, Taipei (TW)

(72) Inventors: Shang-Kai HUANG, New Taipei City (TW); Shan CHIN, New Taipei City (TW)

(73) Assignee: Institute for Information Industry, TAIPEI (TW)

(21) Appl. No.: 13/754,876

(22) Filed: Jan. 30, 2013

(30) Foreign Application Priority Data
Nov. 20, 2012 (TW) 101143305

(51) Int. Cl. H04L 29/06

(52) U.S. Cl. CPC H04L 67/42
USPC 709/203

(57) ABSTRACT

A file-opening system and method are disclosed herein. The method is applied to a network system. The network system includes a local device and a server. The method includes: requesting and receiving a remote application list and supported types of a remote application; modifying at least one file association setting stored in the local device according to the remote application list and the supported types of the remote application; receiving a user command corresponding to a local file in the local device and transmitting a file-opening request to the server, such that the server execute the local file by the remote application according to the file-opening request; and, receiving a real time video of the remote application executing the local file transmitted from the server with streaming protocol and displaying the real time video of the remote application.

### RELATED APPLICATIONS

This application claims priority to Taiwan Application Serial Number 101143305, filed Nov. 20, 2012, which is herein incorporated by reference.

### BACKGROUND

1. Field of Invention

The present disclosure relates to a network system and an operating method thereof. More particularly, the invention relates to a file-opening system a file-opening method.

2. Description of Related Art

With advances in network technology, various network application has been widely used in human life, such as remote desktop, remote monitoring, and so on.

Typically, for achieving a purpose of virtualizing applications, a remote application in a server can be used to execute a local file in a local device.

In U.S. Pat. No. 7,865,538, an information management system is disclosed, in which the remote application can be used to execute a local file with streaming technology, so as to virtualize the applications. However, in this system, operations have to be performed through browsers and complex steps are needed, and therefore causing inconvenience to the user. In addition, in U.S. Pat. No. 8,117,240, a remote application linking infrastructure is disclosed, in which the remote application can also be used to execute a local file. Yet, in this infrastructure, the user has to build a folder corresponding to the remote application, and the user can not directly open the local file in the local device. Therefore, it is also inconvenience to the user for using such an infrastructure.

In view of the above, a method for virtualizing applications and being convenience for use to the user should be provided.

### SUMMARY

One aspect of the present invention is a file-opening method. In accordance with one embodiment of the present invention, the file-opening method is applied to a network system. The network system includes a local device and a server. The server stores at least one remote application. The method includes: requesting and receiving a remote application list and supported file types of the remote application; modifying at least one file association setting stored in the local device according to the remote application list and the supported file types of the remote application; receiving a user command corresponding to a local file of the local device, and transmitting a file-opening request to the sever according to the user command and the at least one file association setting, such that the server executes the local file by the remote application according to the file-opening request; and receiving a real time video of the remote application executing the local file transmitted from the server with streaming protocol and displaying the real time video of the remote application.

Another aspect of the present invention is a file-opening system. The file-opening system includes a server and a local device. The server is configured to store at least one remote application. The local device includes a display component, a storage component, and a processing component. The storage component is configured to store a plurality of file association settings and at least one local file. The processing component includes a control module and an agent module. The agent module is configured for requesting and receiving a remote application list and supported file types of the remote application from the server, and modifying at least one of the file association settings of the local device according to the remote application list and the supported file types of the remote application. When the control module receives a user command, and transmits a file-opening command to the agent module according to the user command and the at least one of the file association settings, the agent module receives and transmits a file opening request to the server according to the file opening command, such that the server executes the local file by the remote application according to the file-opening request, wherein the agent module is further configured to receive a real time video of the remote application executing the local file transmitted from the server with streaming protocol and make the display component display the real time video of the remote application.

### BRIEF DESCRIPTION OF THE DRAWINGS

The invention can be more fully understood by reading the following detailed description of the embodiment, with reference made to the accompanying drawings as follows:

FIG. 1 is a schematic diagram of a file-opening system in accordance with one embodiment of the present disclosure;

FIG. 2 is a flow chart of a file-opening method in accordance with one embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

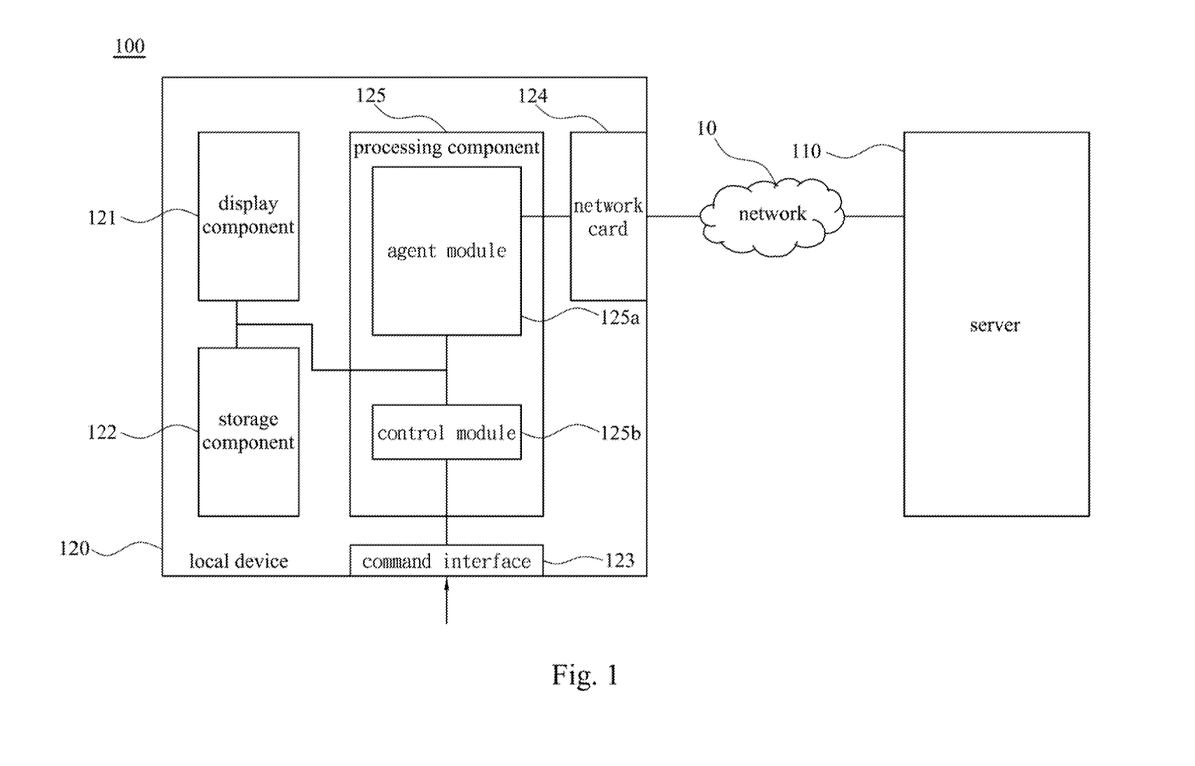

FIG. 1 is a schematic diagram of a file -opening system 100 in accordance with one embodiment of the present disclosure. The file-opening system 100 includes a server 110 and a local device 120. The server 110 can be connected with the local device 120 via network 10. The server 110 can store at least one remote application, such as Microsoft® Word and Microsoft® Excel.

The local device 120 is, for example, a computer. The local device 120 can includes a display component 121, a storage component 122, a command interface 123, a network card 124 and a processing component 125. The storage component 122 can be any kind of the storage device, such as a hard disk, or a memory. The storage component 122 can be used to store file association settings and local files. The file association settings can be, for example, a lookup table. The file association settings can record a plurality of local file types and applications corresponding to the local file types, One of the local files with one of the local file types is, by default, executed by the corresponding application. The local file types can be, for example, filename extensions or multipurpose internet mail extension types (MIME types).

The processing component 125 can be any kind of processing device, such as a central processor, a microprocessor, and so on. The processing component 125 can include an agent module 125a and a control module 125b. In one embodiment, the agent module 125a and the control module 125b can separately execute different applications or threads in the processing component 125.

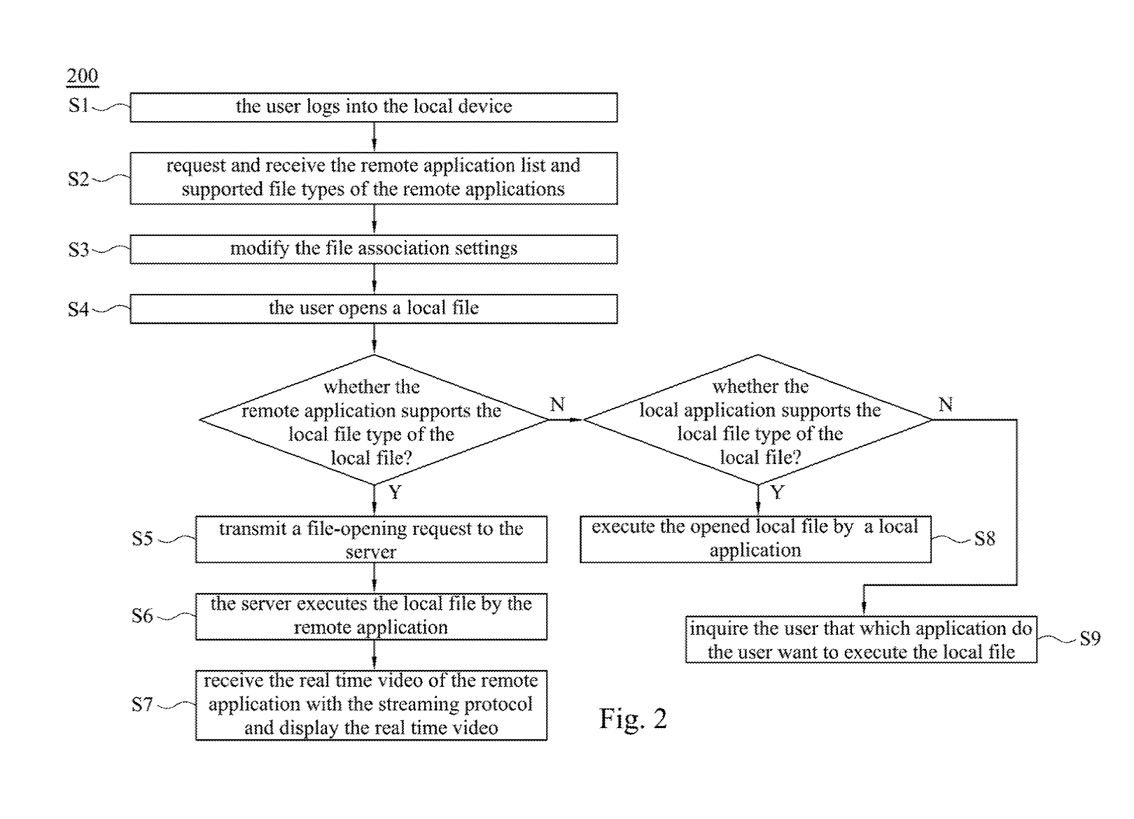

FIG. 2 is a flow chart of a file-opening method 200 in accordance with one embodiment of the present disclosure. The method 200 can be applied to the file-opening system 100, although is not limited to such a system. In the following paragraphs, for convenience in description, the reference will be made to both FIG. 1 and FIG. 2.

The file-opening method can include some or all of the following steps. At first, a user logs into the local device 120 by the command interface 123 (step S1). After the user is logged in, the agent module 125a can transmit a login request through the network card 124 to log into the server 110 and request the server 110 transmit a remote application list and supported file types of the remote applications recorded in the remote application list to the agent module 125a. In addition, the agent module 125a can transmit information store in the storage component 122 (e.g., file directories) to the server through the network card 124, such that the server can access local files stored in the storage component 122.

After receiving the login request transmitted from the agent module 125a, the server 110 can transmit the remote application list and the supported file types of the remote applications recorded in the remote application list to the agent module 125a (step S2). The remote application list can record all or part of remote applications stored in the server 110. In one embodiment, the server 110 can determine the applications recorded in the remote application list transmitted to the agent module 125a according to the identity of the user. One the other hand, the supported file types of the remote applications recorded in the remote application list can be, for example, filename extensions of the remote applications recorded in the remote application list or multipurpose internet mail extension types (MIME types) of the remote applications.

After receiving the remote application list and the supported file types of the remote applications recorded in the remote application list through the is network card 124, the agent module 125a can modify at least one of the file association settings stored in the storage component 122 according to the received remote application list and the supported file types of the remote applications recorded in the remote application list (step S3).

For example, if the remote application list records an remote application such as Microsoft Word, which is stored in the server 110, and the remote application Microsoft® Word supports files with the filename extension being “.doc”, then the agent module 125a can modify at least one of the file association settings, such that all of the local files with the filename extension being “.doc” (e.g., file1.doc) can be executed by the remote application Microsoft® Word by default. More particularly, at least one of file association settings stored in the local device 120 can be modified, such that the local files with the filename extension being “.doc” can be associated to the agent module 125a. That is, the agent module 125a can modify the application corresponding to local file type (e.g., filename extension “.doc”) of the local file (e.g., file1.doc) recorded in at least one of the file association settings, such that the local file type (e.g., filename extension “doc.”) of the local file (e.g., file1.doc) can associated to the agent module 125a. In such a way, when a local file file1.doc is opened (e.g., is double clicked), through the network card 124, the agent w module 125a can request the remote application Microsoft® Word stored in the server 110 to execute the local file file1.doc.

In some embodiments, the agent module 125a can also modify a local application list and a right click pop menu according to the remote application list and the supported file types of the remote applications in the remote application list.

After the at least one of the file association settings stored in the storage component 122 is modified, the user can enter a user command to the local device 120 to open a local file (e.g., enter a double click to the local file such as file1.doc) (step S4). When the control module 125b receives the user command via the command interface 123, the control module 125b can determine that whether to request a remote application (e.g., Microsoft® Word) to execute the local file through the agent module 125a according to the file association settings (that is, according to if the remote application support the local file type (e.g., filename extension) of the local file). If yes, then the control module 125b transmit a file-opening command to the agent module 125 according to the user command. When receiving the file-opening command, the agent module 125a transmits a file-opening request to the server 110 according to the file-opening command through the network card 124 (step S5). In one embodiment, the file-opening request may include, for example, information of the file location (e.g., file directory) of the local file (e.g., file1.doc) to be executed and information of the remote application (e.g., Microsoft® Word) requested to execute the local file.

When the server 110 receives the file-opening request, the server 110 can execute the local file by the requested remote application according to the file-opening request (step S6). The server 110 can form a channel between the server 110 and the local device 120 with the streaming protocol, such as real time streaming protocol (RTSP) or remote desktop protocol (RTP), and transmit a real time video of the remote application executing the local file to the local device 120 through the channel. In response, the agent module 125a can receive the real time video of the remote application transmitted by the server 110 with the streaming protocol and display the real time video of the remote application by the display component 121 (step S7).

In such a way, the user can open one of the local files stored in the local device 120 by one of the remote applications stored in the server 110, and the real time video of the remote application executing the one of the local files can be transmitted to the local device 120 and displayed by the display component of the local device 120. Therefore, applications can be virtualized (that is, can be stored in remote devices).

In addition, in one embodiment, when the control module 125b receives another user command via the command interface 123 to open another one of local files (e.g., file2.ppt), the control module 125b can request a local application (e.g., Microsoft® PowerPoint) to execute the opened local file according to the file association settings (step S8).

In another embodiment, when the control module 125 receives still another user command via the command interface 123 to open still another one of the local files (e.g., file3.unknown), the control module 125b can inquire the user that which application do the user want to execute the local file according to the file association settings (step S9).

In summary, in the embodiments of the invention, the agent module 125a can modify at least one of the file association settings stored in the storage component 122, such that when the user opens one of the local files, one of the remote applications can be used to execute the local file through the agent module 125a. On the other hand, with streaming protocol, the agent module 125a can make the display component 121 in the local device 120 display the real time video of the remote application executing the one of the local files. As a result, the user can seamlessly open one of the local files by one of the mote applications without any change of behaviors.

In addition, in the embodiments of the invention, at least the following profits can be attained:

1. By executing the local files with the remote applications, there is no need for the user installing applications in the local device 120, such that the time used to install the applications can be avoided and the resource of the local device 120 consumed by the applications can be minimized.

2. The user can open the local files of various operating systems by the remote applications on different servers.

3. By modifying the association settings, the user can open the local files by the remote applications without any change of the behaviors (e.g., double click to the local files), and the local files which are not support by local applications can still be executed by the remote applications, such that the ratio to open the local files in success can be increased.

4. The user can open the local files by the remote applications without w utilizing remote desktops or browsers.

5. By installing an application in the server, the application can be used by more than one local device, such that the utilization rate of the application can be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A file-opening method applied to a network system, wherein the network system comprises a local device and a server, the server stores at least one remote application, and the method comprises:
requesting and receiving a remote application list and supported file types of the remote application;
modifying at least one file association setting stored in the local device according to the remote application list and the supported file types of the mote application;
receiving a user command corresponding to a local file of the local device, and transmitting a file-opening request to the sever according to the user command and the at least one file association setting, such that the server executes the local file by the remote application according to the file-opening request; and
receiving a real time video of the remote application executing the local file transmitted from the server with a streaming protocol and displaying the real time video of the remote application.

2. The method as claimed in claim 1, further comprising:
modifying a local application list and a right click pop menu according to the remote application list and the supported file types of the remote application.

3. The method as claimed in claim 1, wherein the supported file types of the remote application are filename extensions of the remote application or are multipurpose internet mail extension types (MIME types) of the remote application.

4. The method as claimed in claim 1, wherein the local device comprises an agent module, the at least one of the file association settings records a local file type of the local file and an application corresponding to the local file type, the step of modifying the at least one file association setting of the local device comprises:
modifying the application corresponding to the local file type of the local to file recorded in the at least one file association setting, such that the local file type of the local file is associated to the agent module.

5. The method as claimed in claim 4, wherein the step of receiving the user command corresponding to the local file of the local device, and transmitting the file-opening request to the sever according to the user command and the at least one file association setting comprises:
transmitting a file-opening command to the agent module according to the user command and the at least one file association setting; and
receiving and corresponding to the file-opening command to transmit the file-opening request through the agent module, wherein the file-opening request corresponds to a file location of the local file and the remote application.

6. A file-opening system, comprising:
a server for storing at least one remote application; and
a local device comprising:
a display component;
a storage component for storing a plurality of file association settings and at least one local file; and
a processing component comprising:
a control module; and
an agent module for requesting and receiving a remote application list and supported file types of the remote application from the server, and modifying at least one of the file association settings of the local device according to the remote application list and the supported file types of the remote application;
wherein when the control module receives a user command, and transmits a file-opening command to the agent module according to the user command and the at least one of the file association settings, the agent module receives and corresponds to the file-opening command to transmits a file opening request to the server, such that the server executes the local file by the remote application according to the file-opening request, wherein the agent module is further configured to receive a real time video of the remote application executing the local file transmitted from the server with streaming protocol and make the display component display the real time video of the remote application.

7. The file-opening system as claimed in claim 6, wherein the agent module is further configured to modify a local application list and a right click pop menu according to the remote application list and the supported file types of the remote application.

8. The file-opening system as claimed in claim 6, wherein the supported file types of the remote application are filename extensions of the remote application or are MIME types of the remote application.

9. The file-opening system as claimed in claim 6, wherein the at least one of the file association settings records a local file type of the local file and an application corresponding to the local file type, the agent module is further configured to modify the application corresponding to local file type of the local file recorded in the at least one of the file association settings, such that the local file type of the local file is associated to the agent module.

10. The file-opening system as claimed in claim 6, wherein the file-opening request corresponds to a file location of the local file and the remote application.
